(19) United States
(12) Patent Application Publication
(10) Pub. No.: US 2026/0233790 A1
(43) Pub. Date: Aug. 13, 2026

(54) REAR SPOILER

(71) Applicant: Honda Motor Co., Ltd., Tokyo (JP)

(72) Inventors: Timothy J. RUPP, Dublin, OH (US); Jesse W. Schlabach, Marysville, OH (US); Timothy W. Lamprey, Marysville, OH (US)

(21) Appl. No.: 19/048,157

(22) Filed: Feb. 7, 2025

(51) Int. Cl. B62D 35/00; B60Q 1/00; B60Q 1/44; B62D 37/02

(52) U.S. Cl. CPC B62D 35/007; B60Q 1/0035; B60Q 1/44; B62D 37/02

(57) ABSTRACT

The disclosure provides a rear spoiler having components arranged to maximize interior space for a Center High Mount Stop Light (CHMSL). The components of the rear spoiler, formed from thermoplastic material(s) in some embodiments, are advantageously attached to one another by welding. By providing streamlined component shapes and welding components together, connection elements are reduced or even eliminated. The reduction or absence of connection elements increases the amount of space available within the rear spoiler to house a CHMSL and its components.

### BACKGROUND

Rear spoilers are a common accessory on a large number of vehicle designs. Spoilers include any of a wide range of structures that attach to the exterior of a vehicle body in order to disrupt, or “spoil”, disadvantageous airflow around the vehicle in order to guide the air flow (which is separating from the body of the vehicle) toward a desired direction. Spoilers may reduce drag, and may also reduce lift, in order to help the vehicle achieve improved performance. Namely, a spoiler may allow a vehicle to achieve improved fuel efficiency or improved stability at high speeds.

A Center High Mount Stop Light (CHMSL) is typically positioned near or within rear spoilers of SUVs to signal braking of the vehicle. This way, people behind the vehicle can detect when the vehicle is braking. In designs in which the CHMSL is positioned within the rear spoiler, it can be quite difficult to construct a rear spoiler that is sleek, thin, rigid, and flows with the lines of the vehicle body while also housing the CHMSL components. Rear spoilers can be made of multiple components that are fastened together. The fasteners, such as mating tongue and groove fasteners, nut and bolt connectors, or clip connectors, can take up space inside the spoiler and reduce the amount of space available for CHMSL components.

There is a need in the art for a system and method that addresses the shortcomings discussed above.

### SUMMARY

In one aspect, the disclosure provides a vehicle comprising a roof, a first lateral side, a second lateral side opposite the first lateral side, and a spoiler. The spoiler can extend rearwardly from the roof and horizontally from the first lateral side of the vehicle to the second lateral side of the vehicle. The spoiler can comprise a first outer component having an outer surface and an inner surface opposite the outer surface. The spoiler can comprise an inner component welded to the inner surface of the first outer component.

In some embodiments, the spoiler can comprise a second outer component fitting together with the first outer component to form both an outer surface of the spoiler and an inner compartment suitable for housing lighting components.

In some embodiments, the first outer component and the inner component can both be formed of a thermoplastic material.

In some embodiments, the first component and the inner component can both be formed of the same type of thermoplastic material.

In some embodiments, the first outer component and the inner component can both be flat along a center region of the spoiler and curve at both a first lateral region of the spoiler and a second lateral region of the spoiler.

In some embodiments, the inner component can lie flush against an inner surface of the first outer component.

In one aspect, the disclosure provides a spoiler configured to extend rearwardly from a roof of a vehicle and horizontally from a first lateral side of the vehicle to a second lateral side of the vehicle that is opposite the first lateral side. The spoiler can comprise a first outer component having an outer surface and an inner surface opposite the outer surface. The spoiler can comprise an inner component welded to the inner surface of the first outer component.

In some embodiments, the spoiler can comprise a second outer component fitting together with the first outer component to form both an outer surface of the spoiler and an inner compartment suitable for housing lighting components.

In some embodiments, the first outer component and the inner component can both be formed of a thermoplastic material.

In some embodiments, the first component and the inner component can both be formed of the same type of thermoplastic material.

In some embodiments, the first outer component and the inner component can both be flat along a center region of the spoiler and curve at both a first lateral region of the spoiler and a second lateral region of the spoiler.

In some embodiments, a second outer component can comprise a single sheet of material folded to form multiple walls including a first wall that is substantially aligned with the first outer component, a second wall that folds away from an outer surface of the first wall at an angle of less than 90 degrees, and a third wall that folds away from an outer surface of the second wall at an angle of more than 90 degrees such that the third wall is spaced apart from the first wall and the space between the first wall and the third wall decreases toward the second wall.

In some embodiments, the inner component can be a single sheet of material folded to form multiple walls including a first wall and a second wall.

In some embodiments, the first wall of the inner component can lie flush against and be welded to the inner surface of the first outer component.

In some embodiments, the second wall of the inner component can be spaced apart from the first wall of the inner component and can lie flush against and can be welded to an inner surface of the third wall of the second outer component.

In one aspect, the disclosure provides a spoiler that can include a first outer component configured to extend rearwardly from a roof of vehicle and horizontally from a first lateral side of the vehicle to a second lateral side of the vehicle that is opposite the first lateral side. The first outer component can include a first slanted edge at a first terminal end. The spoiler can include a second outer component fitting together with the first outer component to form both an outer surface of the spoiler and an inner compartment suitable for housing lighting components. The second outer component can be a single sheet of material folded to have multiple walls including a first wall having a second slanted edge at a second terminal end. The first wall can be substantially aligned with the first outer component. The second slanted edge of the first outer component can be substantially parallel with the first slanted edge. An inner component can be welded to inner surfaces of both the first outer component and the second outer component.

In some embodiments, the first outer component, the second outer component, and the inner component can all be formed of a thermoplastic material.

In some embodiments, the second outer component can include a second wall that folds away from an outer surface of the first wall at an angle of less than 90 degrees.

In some embodiments, the second outer component can include a third wall that folds away from an outer surface of the second wall at an angle of more than 90 degrees such that the third wall is spaced apart from the first wall and the space between the first wall and the third wall decreases toward the second wall.

In some embodiments, the inner component can be a sheet of material folded to have multiple walls. The multiple walls can include a fourth wall welded to the first outer component. The multiple walls can include a fifth wall that folds away from an inner surface of fourth wall and toward the third wall. The multiple walls can include a sixth wall that folds away from the fifth wall and toward the second wall. The sixth wall can be welded to the third wall.

In some embodiments, the inner component can further include a seventh wall that folds away from the sixth wall and toward the first outer component such that the fifth wall, the sixth wall, and the seventh wall together form a valley shape. The inner component can further include an eighth wall that folds away from the seventh wall and toward the second wall. The eighth wall can be welded to both the first outer component and the second outer component.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is an isometric view of a sport utility vehicle with a rear spoiler according to an embodiment.

FIG. 2 is a rear elevation view of the rear spoiler according to an embodiment.

FIG. 3 is a front elevation view of the rear spoiler according to an embodiment.

FIG. 4 is a cross-sectional view of the rear spoiler along arrow 4-4 of FIG. 3.

FIG. 5 is a cross-sectional view of the rear spoiler along arrow 5-5 of FIG. 3.

### DESCRIPTION OF EMBODIMENTS

The disclosure provides a rear spoiler for a vehicle. According to various embodiments, the rear spoiler may provide improved fuel efficiency and vehicle stability. The rear spoiler is designed to have a sleek fit and finish blending into the lines of the vehicle while both providing sufficient rigidity and housing a CHMSL and its components. These design objectives are difficult to achieve in a single design because creating a sleek fit and finish on the outer visible parts of the rear spoiler while also providing sufficient rigidity offers little space inside the rear spoiler for a CHMSL and its components. CHMSL components commonly include light emitting diodes and an electrical circuit powering and controlling the light emitting diodes. While CHMSL components are designed to be increasingly smaller, rear spoilers often still need to compromise the size of outer dimensions to provide sufficient internal space to accommodate CHMSL components. In other words, rear spoilers end up larger/bulkier than desired to fit both connection components and CHMSL components. Embodiments of the present rear spoiler eliminate connection components by utilizing welding. Welding rear spoiler components directly to one another eliminates the need for mechanical connection components that take up space inside the rear spoiler and obstruct the placement of CHMSL components.

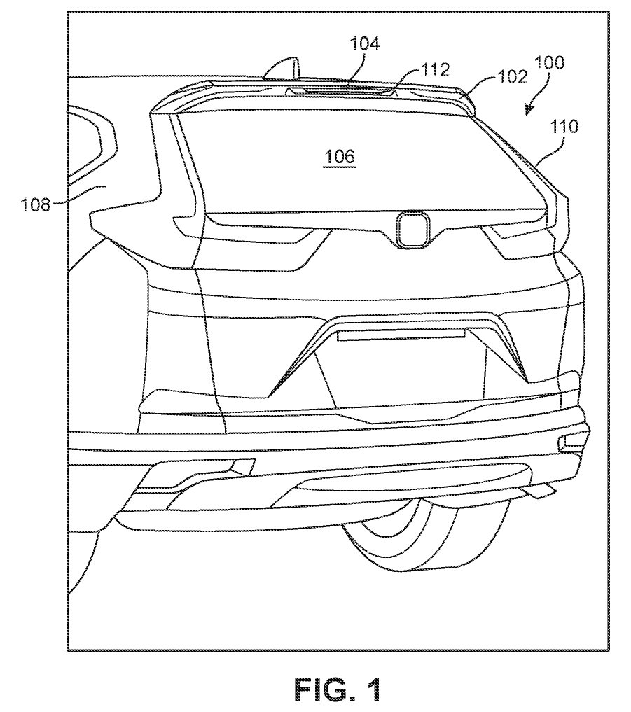

FIG. 1 is an isometric view of a vehicle 100 with a rear spoiler 102, according to an embodiment. Vehicle 100 is a sport utility vehicle. It is understood that the rear spoiler may be used with any type of vehicle having a rearward-facing surface. Vehicle 100 has a first lateral side 108 of vehicle 100 and a second lateral side 110 opposite first lateral side 108. Rear spoiler 102 extends rearwardly from a roof of vehicle 100 in a position situated above a rear window 106 of vehicle 100. It is understood that the rear spoiler may be situated in another location on other vehicles. As shown in FIG. 1, rear spoiler 102 extends horizontally from first lateral side 108 of vehicle 100 to second lateral side 110 of vehicle 100. Rear spoiler 102 includes a CHMSL 104 that is centered within rear spoiler 102 and visible through a first cutout/opening 112 of rear spoiler. When a brake of vehicle 100 is applied, CHMSL 104 can light up to indicate that the vehicle is slowing down and/or stopping.

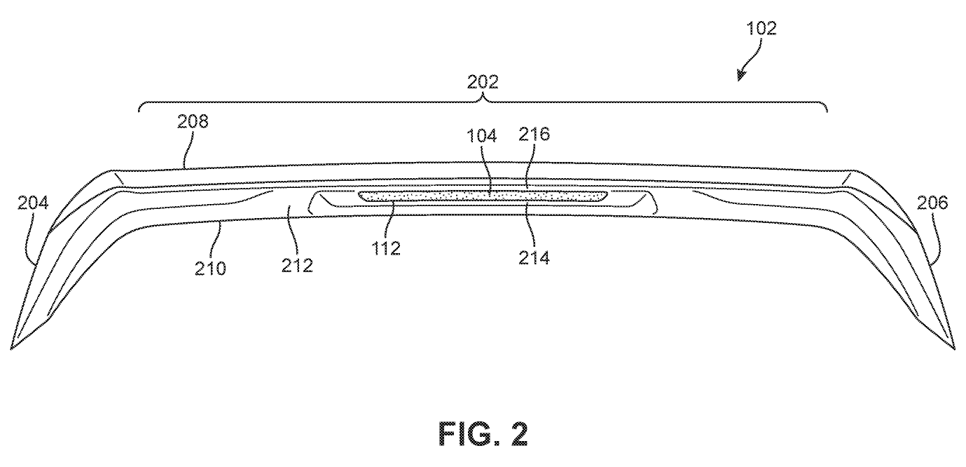

FIG. 2 is a rear elevation view of rear spoiler 102 in isolation from vehicle 100. The outer body of rear spoiler 102 includes first outer surface 208 and second outer surface 210 opposite first outer surface 208. In the orientation shown in FIG. 2, first outer surface 208 is a top or upper outer surface and second outer surface 210 is a bottom or lower outer surface. The center region 202 of rear spoiler 102 is substantially flat along a first outer surface 208 of rear spoiler 102 and along a second outer surface 210 of rear spoiler. Rear spoiler 102 curves at a first lateral region 204 and a second lateral region 206 opposite first lateral region 204. As shown in FIG. 1, these smooth contours of rear spoiler’s center region 202, first lateral region 204, and second lateral region 206 contribute to the fit and finish of the vehicle by following and blending with the lines of vehicle 100. In some embodiments, it is desirable to enhance the fit and finish of the vehicle by minimizing the distance between first outer surface 208 and second outer surface 210 to provide a thin, sleek rear spoiler.

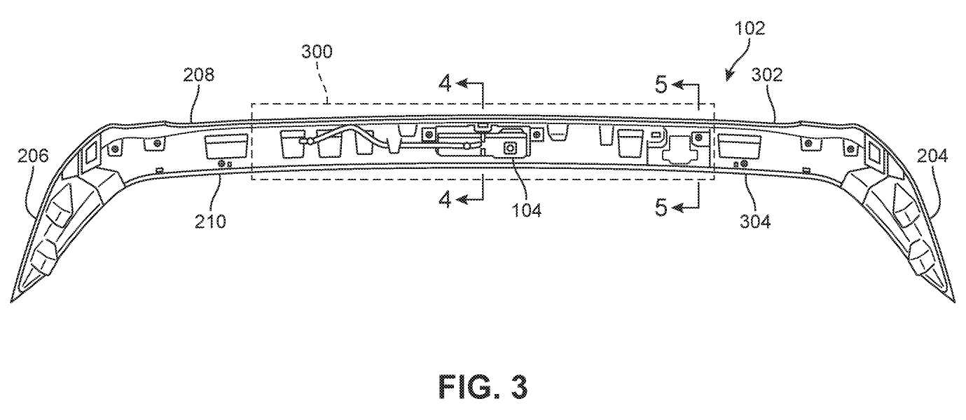

FIG. 3 is a front elevation view of rear spoiler 102 in isolation from vehicle 100. The view in FIG. 3 reveals the innards of rear spoiler 102. Box 300 indicates a portion of rear spoiler 102 where CHMSL 104 and its components can be positioned.

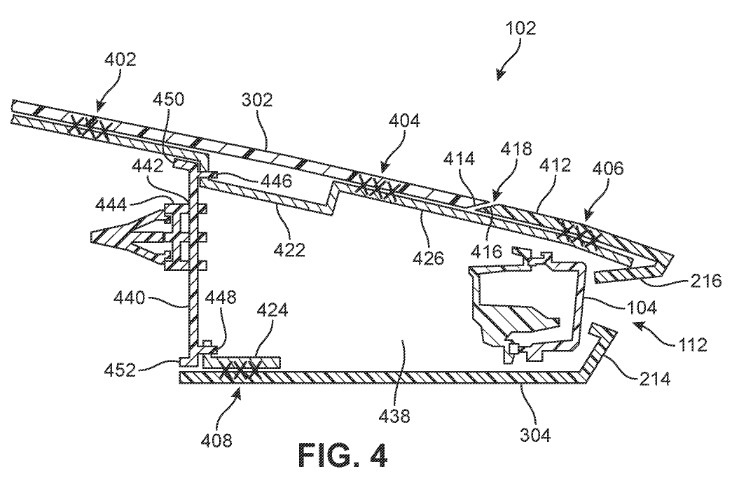

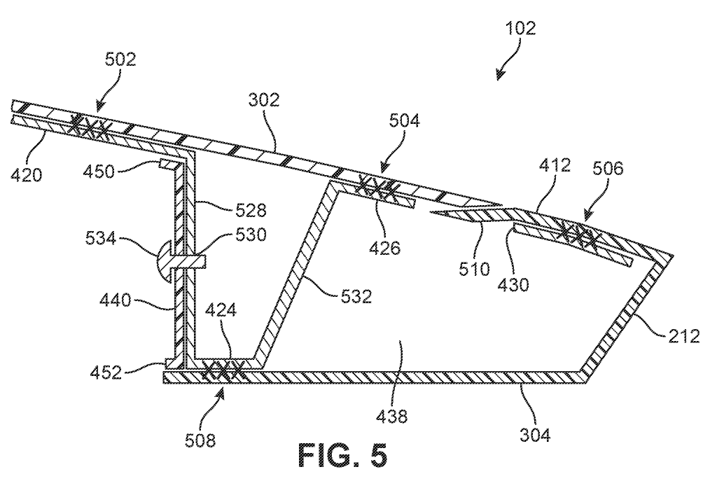

FIG. 4 is a cross-sectional view of rear spoiler 102 along arrow 4-4 of FIG. 3. Arrow 4-4 is located within the area of box 300 where the CHMSL and its components are housed. FIG. 5 is a cross-sectional view of the rear spoiler along arrow 5-5 of FIG. 3, which is outside of the area of box 300. As shown in FIGS. 4 and 5, rear spoiler 102 is composed of multiple components, or elements, that, as discussed in more detail below, are welded together at a first attachment area 402, a second attachment area 404, a third attachment area 406, a fourth attachment area 408, fifth attachment area 502, sixth attachment area 504, seventh attachment area 506, and eighth attachment area 508.

Rear spoiler 102 includes a first outer component 302. First outer component 302 is a sheet of material is a continuous wall or sheet that is substantially flat along center region 202 of rear spoiler 102 and curves at a first lateral region 204 and a second lateral region 206. First outer component 302 has an outer surface that forms part of first outer surface 208 of rear spoiler 102. First outer component 302 has an inner surface that is opposite its outer surface. The inner surface of first outer component 302 is substantially parallel to the outer surface of first outer component 302 such that the thickness of first outer component 302 defined between its inner and outer surfaces is relatively constant throughout. First outer component 302 has a first slanted edge 414 at a terminal end. First slanted edge 414 forms a 45-degree angle with both the inner and outer surfaces of first outer component 302.

Rear spoiler 102 includes a second outer component that is formed separately from first outer component 302. As shown in FIGS. 2 and 4, the second outer component is a single component formed by a first wall 412, a second wall 304, a third wall 216, fourth wall 214, and a fifth wall 212. The multiple walls of the second outer component integrally form the second outer component. The second outer component is a continuous wall or sheet that is generally folded as shown in FIG. 5 and contoured as shown in FIG. 3. The multiple walls of the second outer component are separately referenced to help explain the shape of the second outer component and how the second outer component is related to and attached to other components of rear spoiler 102. First wall 412 is substantially flat along center region 202 of rear spoiler 102 and curves at a first lateral region 204 and a second lateral region 206.

First wall 412 has an outer surface that forms part of first outer surface 208 of rear spoiler 102. First wall 412 is substantially aligned with first outer component 302. Together, the outer surfaces of first wall 412 and first outer component 302 form first outer surface 208. First wall 412 has an inner surface that is opposite its outer surface. The inner surface of first wall 412 is substantially parallel to the outer surface of first wall 412 such that the thickness of first wall 412 defined between its inner and outer surfaces is relatively constant throughout. First wall 412 has a second slanted edge 416 at a terminal end. Second slanted edge 416 forms a 45-degree angle with both the inner and outer surfaces of first wall 412. First slanted edge 414 is parallel to second slanted edge 416. As shown in FIG. 4, in an attached configuration/position, first slanted edge 414 and second slanted edge 416 are spaced apart at 418 by a small distance, such as a distance greater than 0 mm and less than 1 mm. For example, in some embodiments, first slanted edge 414 and second slanted edge 416 are spaced apart by 0.2 mm. In some embodiments, the first slanted edge and second slanted edge are abutting without a space between them. While the slanted edges are shown as forming a 45-degree angle with respect to the outer and inner surfaces surrounding the slanted edges, in some embodiments, the angle may be between 30 degrees and 60 degrees. The 45-degree configuration of the terminal edges at the portion of the first outer component and the first wall provides a thinner connection point where the CHMSL and its components are located to provide more space thereunder for the CHMSL and its components.

As shown in FIG. 5, fifth wall 212 folds away from an outer surface of first wall 412 at an angle of less than 90 degrees. In other words, the angle between first wall 412 and fifth wall 212 is less than 90 degrees. Second wall 304 folds away from an outer surface of fifth wall 212 at an angle of more than 90 degrees such that the third wall is spaced apart from the first wall and the space between first wall 412 and second wall 304 decreases toward the fifth wall 212. In other words, the angle between fifth wall 212 and second wall 304 is more than 90 degrees, and this angle causes second wall 304 to extend at an angle with respect to first outer component 302 and first wall 412. Second wall 304 is not parallel to first outer component 302 or first wall 412. This relationship causes the distance between second wall 304 and first outer component 302 to taper toward fifth wall 212. Similarly, this relationship causes the distance between second wall 304 and first wall 412 to taper toward fifth wall 212. This tapering enhances the aerodynamic profile of the spoiler and the vehicle. In some embodiments, the angle of first outer component 302 and first wall 412 can depend on the shape of the roof of the vehicle.

First outer component 302 and the second outer component fit together to form an outer body of rear spoiler 102 having an inner compartment 438 suitable for housing lighting components. In other words, inner compartment 438 has a volume sufficient to house a CHMSL and its components. Rear spoiler 102 includes a CHMSL bracket 440 that encloses inner compartment 438. CHMSL bracket 440 is flat and includes a first flange 450 and a second flange 452. First flange 450 rests against sixth wall 420 and second flange 452 rests against second wall 304 to help secure CHMSL bracket 440 in place and to further reinforce rigidity. First flange 450 and second flange 452 can extend along the entire length of CHMSL bracket 440. In some embodiments, first flange 450 and second flange 452 can each be replaced with multiple flanges that are spaced apart along the length of CHMSL bracket 440.

CHMSL bracket 440 can include various openings for wires, screws, and brackets. For example, as shown in FIG. 4, closure wall 440 has a hole 442 to allow CHMSL component 444 to fit through CHMSL bracket 440. In another example, as shown in FIG. 5, CHMSL bracket 440 may include a hole 530 through which a screw 534 may fit through to connect CHMSL bracket 440 to ninth wall 528.

Second wall 304 of the second outer component forms second outer surface 210. Second outer surface 210 corresponds with first outer surface 208 such that the two surfaces follow similar lines along center region of rear spoiler 102. Similar to first outer surface 208, second outer surface 210 is substantially flat along center region 202 of rear spoiler 102 and curves at a first lateral region 204 and a second lateral region 206. As shown in FIGS. 4 and 5, second wall 304 of the second outer component is substantially consistent in position relative to first outer component 302 and first wall 412 along area of box 300 and at area adjacent arrow 5-5.

Rear spoiler 102 includes an inner component disposed within inner compartment 438 of rear spoiler to reinforce the rigidity of rear spoiler 102. The inner component comprises a sheet of material folded to have portions attached to first outer component 302, as well as first wall 412 and second wall 304 of the second outer component. The inner component is a single component formed by a sixth wall 420, a seventh wall 424, an eighth wall 426, a ninth wall 528, a tenth wall 532, and eleventh wall 422. The multiple walls of the inner component integrally form the second outer component. The multiple walls of the second outer component are separately referenced to help explain the shape of the inner component and how the inner component is related to and attached to other components of rear spoiler 102.

Sixth wall 420 and eighth wall 426 are substantially aligned with each other and are substantially parallel with first outer component 302 and first wall 412 of the second outer component. Eighth wall 426 includes second cutout/opening 430. Second cutout/opening 430 allows for flap 510 to rest beneath first outer component 302. In some embodiments, the first wall 412 is the same shape along arrow 5-5 as first wall 412 is at arrow 4-4. In such embodiments, first wall 412 does not include flap 510 and eighth wall 426 does not include second cutout/opening 430. As shown in FIG. 5, the inner component folds from sixth wall 420 to form seventh wall 424, ninth wall 528, and tenth wall 532. Ninth wall 528 folds away from an inner surface of sixth wall 420 and toward second wall 304. Seventh wall 424 folds away from ninth wall 528 and toward fifth wall 212. Tenth wall 532 folds away from seventh wall 424 and toward first outer component 302. Ninth wall 528 and tenth wall 532 reinforce rigidity within rear spoiler 102. Together, seventh wall 424, ninth wall 528, and tenth wall 532 form a valley shape. Seventh wall 424 is substantially horizontal. Ninth wall 528 and tenth wall 532 are both substantially vertical. Tenth wall 532 is slightly sloped in comparison with ninth wall 528. It is understood that in other embodiments, each of ninth wall 528 and tenth wall 532 may be more or less sloped. As shown in FIG. 4, the shape of the inner component is different at arrow 4-4. At arrow 4-4, the inner component folds from sixth wall 420 to form eleventh wall 422 to provide room for CHMSL 104 and its components. Eighth wall 426 folds away from tenth wall 532 and toward fifth wall 212.

CHMSL bracket 440 may have protrusions that can connect with other components inside inner compartment 438. For example, as shown in FIG. 4, CHMSL bracket 440 includes a first protrusion 446 connecting to the inner component. In another example, as shown in FIG. 4, CHMSL bracket 440 includes a second protrusion 448 connecting to seventh wall 424.

FIGS. 2, 4 and 5 together show how rear spoiler 102 transitions from a solid wall at fifth wall 212 to an area where a third wall 216 and a fourth wall 214 define first cutout 112. First cutout/opening 112 allows visibility of CHMSL 104. As discussed below, first wall 412 is welded to the inner component at a third attachment area 406. In some embodiments, the portion of first wall 412 represented in FIG. 5 may be the same as the portion of first wall 412 in FIG. 4 with second slanted edge 416 instead of a flap 510.

In FIG. 4, first outer component 302 is parallel with and adjacent to sixth wall 420 at a first attachment area 402. First outer component 302 may be flush against sixth wall 420. The x’s at first attachment area 402 indicate welding between the first outer component and the inner component. First outer component 302 is parallel with and adjacent to eighth wall 426 at a second attachment area 404. First outer component 302 may be flush against eighth wall 426. The x’s at second attachment area 404 indicate welding between the first outer component and the inner component. First wall 412 is parallel with and adjacent to eighth wall 426 at a third attachment area 406. First wall 412 may be flush against eighth wall 426. The x’s at third attachment area 406 indicate welding between the first outer component and the inner component. Second wall 304 is parallel with and adjacent to seventh wall 424 at a fourth attachment area 408. Second wall 304 may be flush against seventh wall 424. The x’s at fourth attachment area 408 indicate welding between the first outer component and the inner component.

Referring to FIG. 5, which again is a cross-sectional view of the rear spoiler along arrow 5-5 of FIG. 3, the attachment areas are similar to those shown in FIG. 4. First outer component 302 is parallel with and adjacent to sixth wall 420 at a fifth attachment area 502. First outer component 302 may be flush against sixth wall 420. The x’s at fifth attachment area 502 indicate welding between the first outer component and the inner component. First outer component 302 is parallel with and adjacent to eighth wall 426 at a sixth attachment area 504. First outer component 302 may be flush against eighth wall 426. The x’s at sixth attachment area 504 indicate welding between the first outer component and the inner component. First wall 412 is parallel with and adjacent to eighth wall 426 at a seventh attachment area 506. First wall 412 may be flush against eighth wall 426. The x’s at seventh attachment area 506 indicate welding between the first outer component and the inner component. Second wall 304 is parallel with and adjacent to seventh wall 424 at an eighth attachment area 508. Second wall 304 may be flush against seventh wall 424. The x’s at eighth attachment area 508 indicate welding between the first outer component and the inner component.

According to various embodiments, the attachment between components of the rear spoiler may include welding. For example, ultrasonic welding, hot gas welding, or radio frequency (RF) welding may be performed to attach components of the rear spoiler to one another. By welding components together, no mechanical connectors are necessary. In comparison with other attachment techniques, welding creates a stronger bond by melting plastic together and allowing the melted plastics to cool and solidify. The components may have smooth surfaces without bulky connectors, such as protrusions, snaps, tongue & groove connectors, etc. The welds can have a much smaller thickness than any mechanical connectors. By eliminating connectors, even smaller connectors, the smooth surfaces of the rear spoiler components are unencumbered and allow for more space inside the rear spoiler. As a result, the outer dimensions of the rear spoiler may be reduced for an improved fit and finish and the rear spoiler may still allow for a compartment sufficiently large to house the CHMSL components.

The components of rear spoiler 102 may be formed from various thermoplastic materials. For example, the components may be formed from Acrylonitrile Butadiene Styrene (ABS), Acrylonitrile-(ethylene-propylene-diene)-styrene (AEPDS), Acrylonitrile styrene acrylate (ASA), acrylonitrile ethylene styrene (AES), polystyrene etc. In some embodiments, the components may be all formed from the same material. For example, the first outer component 302 and inner component may be made of the same thermoplastic material. In other embodiments, the components may be formed from different materials. For example, the first outer component 302 may be made of ASA while inner component is made from ABS. The material of the components of the rear spoiler may be selected based upon a variety of factors. For example, it is advantageous for the materials to be selected to be compatible for welding the components together. In some situations, using the same material for all of the components that are to be welded ensures successful welding. In other situations, when selecting different materials for different components that are to be welded together, selecting compatible materials can help create successful welds. Compatible materials can include materials that weld together easily to form a strong attachment. For example, materials having similar melting points can weld well together. In some cases, a binder may be used to create the weld. For example, an AES binder may be used to create a weld joint between a component made of ABS and a component made of ASA.

The materials may also be selected based on manufacturing considerations other than welding capabilities. For example, materials may be selected based on ease of achieving rear spoiler component shapes, such as by molding processes. The materials may further be selected based on strength, durability, flexibility, and weight desired. For example, a material may be selected based on a balance between a light weight and high strength/durability in comparison with other materials.

While various embodiments of the disclosure have been described, the description is intended to be exemplary, rather than limiting and it will be apparent to those of ordinary skill in the art that many more embodiments and implementations are possible that are within the scope of the disclosure. Various modifications and changes may be made within the scope of this disclosure.

We claim:

1. A vehicle comprising:
a roof;
a first lateral side;
a second lateral side opposite the first lateral side; and
a spoiler extending rearwardly from the roof and horizontally from the first lateral side of the vehicle to the second lateral side of the vehicle, the spoiler comprising:
a first outer component having an outer surface and an inner surface opposite the outer surface; and
an inner component welded to the inner surface of the first outer component.

2. The vehicle of claim 1, wherein the spoiler comprises a second outer component fitting together with the first outer component to form both an outer surface of the spoiler and an inner compartment suitable for housing lighting components.

3. The vehicle of claim 1, wherein the first outer component and the inner component are both formed of a thermoplastic material.

4. The vehicle of claim 3, wherein the first component and the inner component are both formed of the same type of thermoplastic material.

5. The vehicle of claim 1, wherein the first outer component and the inner component are both flat along a center region of the spoiler and curve at both a first lateral region of the spoiler and a second lateral region of the spoiler.

6. The vehicle of claim 1, wherein the inner component lies flush against an inner surface of the first outer component.

7. A spoiler configured to extend rearwardly from a roof of a vehicle and horizontally from a first lateral side of the vehicle to a second lateral side of the vehicle that is opposite the first lateral side, the spoiler comprising:
a first outer component having an outer surface and an inner surface opposite the outer surface; and
an inner component welded to the inner surface of the first outer component.

8. The spoiler of claim 7, wherein the spoiler comprises a second outer component, the first outer component and the second outer component fitting together to form both an outer surface of the spoiler and an inner compartment suitable for housing lighting components.

9. The spoiler of claim 7, wherein the first outer component and the inner component are both formed of a thermoplastic material.

10. The spoiler of claim 9, wherein the first component and the inner component are both formed of the same type of thermoplastic material.

11. The spoiler of claim 7, wherein the first outer component and the inner component are both flat along a center region of the spoiler and both curve at both a first lateral region of the spoiler and a second lateral region of the spoiler.

12. The spoiler of claim 11, further comprising a second outer component comprising a single sheet of material folded to form multiple walls including:
a first wall that is substantially aligned with the first outer component;
a second wall that folds away from an outer surface of the first wall at an angle of less than 90 degrees; and
a third wall that folds away from an outer surface of the second wall at an angle of more than 90 degrees such that the third wall is spaced apart from the first wall and the space between the first wall and the third wall decreases toward the second wall.

13. The spoiler of claim 12, wherein the inner component is a single sheet of material folded to form multiple walls including a first wall and a second wall.

14. The spoiler of claim 13, wherein the first wall of the inner component lies flush against and is welded to the inner surface of the first outer component.

15. The spoiler of claim 14, wherein the second wall of the inner component is spaced apart from the first wall of the inner component and lies flush against and is welded to an inner surface of the third wall of the second outer component.

16. A spoiler comprising:
a first outer component configured to extend rearwardly from a roof of vehicle and horizontally from a first lateral side of the vehicle to a second lateral side of the vehicle that is opposite the first lateral side, the first outer component including a first slanted edge at a first terminal end;
a second outer component fitting together with the first outer component to form both an outer surface of the spoiler and an inner compartment suitable for housing lighting components, wherein the second outer component is a single sheet of material folded to have multiple walls including a first wall having a second slanted edge at a second terminal end, wherein the first wall is substantially aligned with the first outer component and wherein the second slanted edge of the first outer component is substantially parallel with the first slanted edge; and
an inner component welded to inner surfaces of both the first outer component and the second outer component.

17. The spoiler of claim 16, wherein the first outer component, the second outer component, and the inner component are all formed of a thermoplastic material.

18. The spoiler of claim 17, wherein the second outer component includes:
a second wall that folds away from an outer surface of the first wall at an angle of less than 90 degrees; and
a third wall that folds away from an outer surface of the second wall at an angle of more than 90 degrees such that the third wall is spaced apart from the first wall and the space between the first wall and the third wall decreases toward the second wall.

19. The spoiler of claim 18, wherein the inner component is a sheet of material folded to have multiple walls including:
a fourth wall welded to the first outer component;
a fifth wall that folds away from an inner surface of fourth wall and toward the third wall; and
a sixth wall that folds away from the fifth wall and toward the second wall, wherein the sixth wall is welded to the third wall.

20. The spoiler of claim 19, wherein the inner component further includes:
a seventh wall that folds away from the sixth wall and toward the first outer component such that the fifth wall, the sixth wall, and the seventh wall together form a valley shape;
an eighth wall that folds away from the seventh wall and toward the second wall, wherein the eighth wall is welded to both the first outer component and the second outer component.
